(19) United States
(12) Patent Application Publication
(10) Pub. No.: US 2010/0283591 A1
(43) Pub. Date: Nov. 11, 2010

(54) Method for graphically representing a danger for the driver of a motor vehicle

(76) Inventor: Jens Schick, Herrenberg (DE)

Correspondence Address: KENYON & KENYON LLP, ONE BROADWAY, NEW YORK, NY, 10004, US

(21) Appl. No.: 12/308,334

(22) PCT Filed: Sep. 4, 2007
(86) PCT No.: PCT/EP2007/059237

§ 371 Date: Jul. 28, 2010

(30) Foreign Application Priority Data
Oct. 19, 2006 (DE) 10 2006 049 249.8

(51) Int. Cl. B60Q 1/00

(52) U.S. Cl. 340/436

(57) ABSTRACT

A method for informing the driver of a motor vehicle via a driver information system, which has at least one detection unit, at least one evaluation unit, and at least one optical display unit. The display unit displays the motor vehicle having the driver information system as a graphical representation, an aura representation surrounding the graphical representation when, based on the evaluation of data from the detection unit, the evaluation unit determines that there is no immediate danger. If an imminent danger is ascertained in a corresponding manner, the aura representation changes or disappears, and at least one supplementary information item for avoiding danger is displayed.

### FIELD OF THE INVENTION

The present invention relates to a method for informing the driver of a motor vehicle via a driver information system, which has at least one detection unit, at least one evaluation unit, and at least one optical display unit.

### BACKGROUND INFORMATION

Methods of the type described at the outset serve the purpose of alerting the driver of a motor vehicle to possible dangers during vehicle operation. Data describing the surrounding field of the motor vehicle are recorded by a detection unit, which includes radar sensors and/or laser sensors, evaluated by an evaluation unit, and indicated to the driver via an optical display unit, it being possible, for example, for the display unit to be a display in the instrument panel area of the motor vehicle or a heads-up display, which projects a display onto the windshield of the motor vehicle.

From the German Patent Application publications DE 102 47 563 A1 and DE 10 2004 014 671 A1, methods are discussed which employ supplementary symbols to indicate dangers. Thus, for example, a motor vehicle approaching from the side is visually emphasized in color in the heads-up display.

The German Patent Application DE 10 2004 001 113 A1 discusses a method which, on the basis of recorded data, graphically shows an avoidance maneuver, for example, as an arrow in the heads-up display, to the driver.

The European Patent Application EP 1 355 285 A1 discusses a method for informing the driver of a motor vehicle where a view from above one's own vehicle, including its immediate vicinity, is graphically represented, and an arrow is optionally used to indicate the direction of movement of one's own motor vehicle, no indication of imminent danger being given to the driver.

### SUMMARY OF THE INVENTION

In accordance with the present invention, the display unit displays the motor vehicle having the driver information system as a graphical representation, an aura representation surrounding the graphical representation when, based on the evaluation of data from the detection unit, the evaluation unit determines that there is no immediate danger. If an imminent danger is ascertained in a corresponding manner, the aura representation changes or disappears, and at least one supplementary information item for avoiding danger is displayed. Thus, when the evaluation unit assesses the current driving situation and, on the basis of the data recorded by the detection unit, determines that there is no imminent danger to the motor vehicle, the display unit shows a graphic representation of the motor vehicle surrounded by an aura representation. The aura representation is to be understood as a halo or color field around the motor vehicle that increases in transparency toward the outside, for example. The aura representation is advantageously tinted in a way that allows the driver of the motor vehicle to easily discern, even from the corner of the eye, that there is no imminent danger. However, if a danger is detected, the aura disappears and/or changes and/or advantageously dims completely, and supplementary information for avoiding danger is indicated, the change in the aura being able to connote not only a change in color, but also a change in shape. The disappearance of the aura representation is easily discerned by the driver and causes him/her to direct his/her attention to the display unit. The supplementary information on avoiding danger quickly informs the driver of the steps to be taken to avoid danger. The supplementary information obviates the need for the driver to be concerned about assessing the current driving situation, so that he/she does not need to first analyze the displayed representation and subsequently decide how to avoid danger. When the method according to the present invention is employed, the driver does not need to lose time since the supplementary information on avoiding danger is already indicated to him/her.

An optical marking identifying the area of the graphically represented vehicle that is at risk is advantageously provided as supplementary information. If the driver is approaching a vehicle in front too closely, for example, then the front section of the graphically represented motor vehicle is colored in a warning color, such as red, for example, it also being possible for the coloration to change in response to increasing danger, so that the front section is first marked by an indicating color, such as yellow, for example, and the coloration changes to the warning color in response to increasing danger. The same applies to a situation, for example, where the driver is driving too closely to a curb, to a wall of a house, or to a motor vehicle traveling next to him/her. The coloration makes it possible for the driver to quickly recognize the area of his/her motor vehicle that is in danger, so that he/she can act accordingly. It is self-evident that the optical marking identifying the area at risk does not need to be exclusively provided as a coloration, but may also be effected, for example, by a border around the endangered area or by a reduction in the color intensity of the rest of the graphically represented motor vehicle.

One further refinement of the present invention provides that a vehicle-control instruction linked to the graphical representation of the motor vehicle be indicated to the driver as supplementary information. This means that a vehicle-control instruction is displayed as a function of the graphical representation of the motor vehicle, whether from the bird's-eye perspective, from the side or the like, enabling the driver to recognize at a glance, how he/she should control the vehicle to avoid the danger. The method according to the present invention not only displays an assessment of the situation to the driver, but also a reaction thereto.

It is advantageously indicated whether the graphically represented area of the motor vehicle that is at risk is endangered by other objects or by one's own driving maneuver. Thus, that area of one's own motor vehicle which is in danger, for example, due to another approaching motor vehicle (in the following, foreign vehicle) and/or due to one's own driving maneuver, such as, for example, driving too fast into or in the curve or pulling up too closely to the vehicle in front, is indicated to the driver.

The supplementary information is advantageously a suggested driving maneuver for the driver and/or a suggested preparation for a driving maneuver for the driver to execute. Thus, not only may a maneuver to be executed, such as braking, accelerating or steering, for example, be recommended to the driver by the display unit, but, in addition or alternatively, also a preparation for a maneuver to be executed, such as actuating the direction indicator, the horn, the shifting of a gear or the like. Thus, the driver is able to react more quickly to a specific driving situation.

The suggested driving maneuver is advantageously indicated by at least one arrow extending out from the graphically represented motor vehicle. This linking of the vehicle-control instruction to the representation of the motor vehicle indicates a suggested driving maneuver to the driver in a simple and unmistakable manner. There is no need for the driver to lose any time interpreting the graphic representation; rather he/she is able to act immediately.

In accordance with one further refinement of the present invention, the display unit indicates at least one supplementary information item on the status of the motor vehicle. The status information concerns, for example, whether and which door of the motor vehicle is open or closed, whether a window is open, whether the doors are locked, whether only the parking light or also the driving light is turned on and/or whether the trunk and/or the engine hood are closed.

The method according to the present invention renders possible a clear graphical representation of the driving situation, not only the imminent danger, but also a suggested possible reaction being indicated to the driver, enabling him/her to act instantaneously.

The present invention is explained in greater detail in the following with reference a few figures.

### BRIEF DESCRIPTION OF THE DRAWING

FIG. 1 shows a first exemplary embodiment of the method according to the present invention when there is no immediate danger.

FIGS. 2a and 2b show a second exemplary embodiment in the case of imminent danger to the front section.

FIGS. 3a and 3b illustrate a third exemplary embodiment in the case of imminent danger to the rear section.

FIGS. 4a and 4b depict a fourth exemplary embodiment in the case of imminent danger to the side section.

FIGS. 5a and 5b show a fifth exemplary embodiment in the case of imminent danger due to a passing vehicle.

FIGS. 6a and 6b illustrate a sixth exemplary embodiment in the case of a danger posed by an obstacle.

FIG. 7a through 7c show a seventh exemplary embodiment in the case of a danger posed by excessive speed.

FIG. 8a through 8d illustrate an eighth exemplary embodiment in the case of a danger posed by an unexpected obstacle.

FIG. 9 shows an exemplary embodiment of the configuration of the display unit.

### DETAILED DESCRIPTION

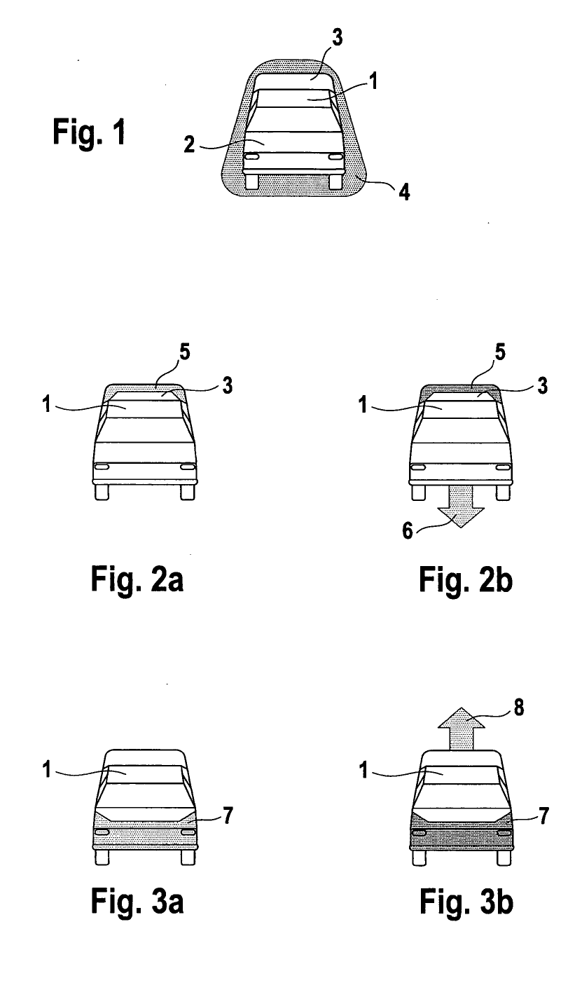

In an oblique rear view from above, FIG. 1 through 8d show a motor vehicle 1 that is graphically represented by a display unit of a driver information system, so that rear section 2 of motor vehicle 1 is completely shown and front section 3 is at least partially shown.

FIG. 1 shows motor vehicle 1, along with an aura representation 4 surrounding the same. Aura representation 4 is advantageously differently colored than graphically represented motor vehicle 1, so that a distinct difference is discernible. FIG. 1 depicts the graphical representation of the display unit for the case that data recorded by a detection unit and analyzed by an evaluation unit do not indicate any imminent danger to one's own motor vehicle. The detection unit and the evaluation unit likewise constitute part of the driver information system.

In an exemplary embodiment, FIGS. 2a and 2b show motor vehicle 1 in the case of a danger to front section 3. If the distance to a vehicle in front is too small, for example, or if the driver information system detects another stationary motor vehicle (in the following, foreign vehicle) ahead of one's own motor vehicle, then an optical marking identifying that area of motor vehicle 1 which is at risk, which, in this case, corresponds to front section 3, is advantageously provided as supplementary information. For example, as graphically represented here, a partial front section 5 is marked in color, allowing the driver to recognize which area of his/her motor vehicle is in danger. In FIG. 2a, partial front section 5 is identified by an indicating color, for example yellow, since the danger posed by the moving or stationary foreign vehicle in front can still be easily avoided. In FIG. 2b, partial front section 5 is marked by a warning color, for example red, thereby indicating that the danger is critical and that the driver urgently needs to react to avoid the danger. Advantageously displayed in this context is a further supplementary information item in the form of an arrow 6, which points to the rear relative to the direction of travel of graphically represented motor vehicle 1 and thereby suggests braking as a driving maneuver to the driver.

Aura representation 4 from FIG. 1 is no longer present in FIG. 2a through 8d, since a danger has been recognized in each of the situations represented in these figures. The disappearance or complete dimming of aura representation 4 easily makes the driver aware that his/her motor vehicle is in danger. The supplementary information, colored partial front section 5 and arrow 6 not only indicate to the driver which area of his/her motor vehicle is in danger, but also how he/she should act to evade the danger.

In another exemplary embodiment, FIGS. 3a and 3b illustrate motor vehicle 1 graphically represented by the display unit for the case that a motor vehicle, which is traveling behind the motor vehicle in question, is pulling up too closely (FIG. 3a) or so quickly that a rear-end collision is imminent (FIG. 3b). For the case that the vehicle behind is merely pulling up too closely, a partial rear section 7 of motor vehicle 1 is marked in color with the indicating color, and, for the case that a rear-end collision is imminent, as depicted in FIG. 3b, it is marked with the warning color. In addition to the color marking, in the case of an imminent rear-end collision, an arrow 8 pointing forward from motor vehicle 1 is shown, thereby suggesting a reaction, namely acceleration, to the driver to avoid danger.

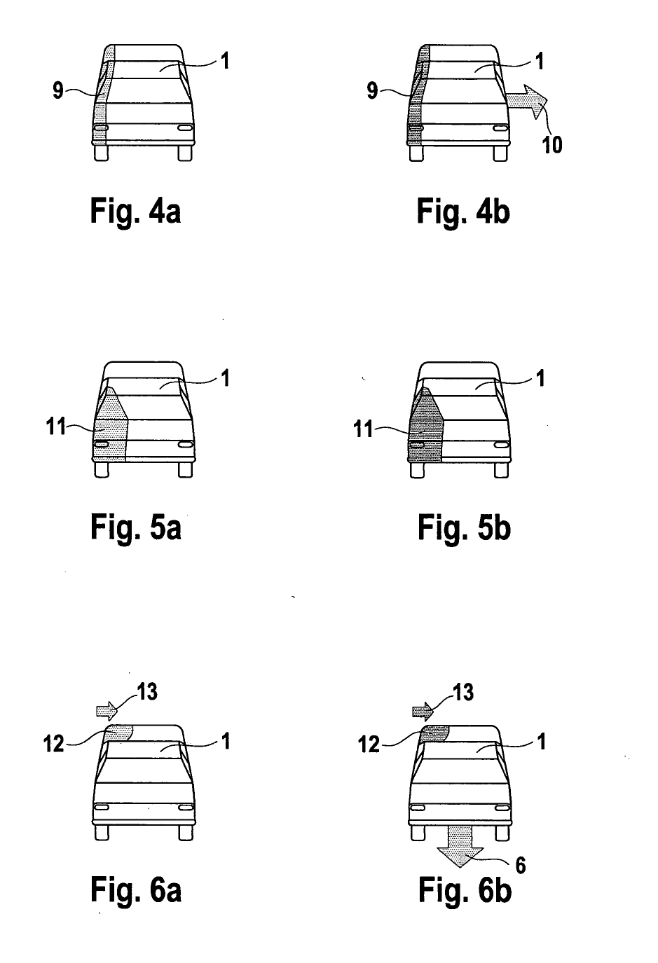

In one exemplary embodiment, FIGS. 4a and 4b show graphically represented motor vehicle 1 for the case that danger from the side is imminent. This may be a foreign vehicle that is traveling next to one's one motor vehicle, for example. In the case that the foreign vehicle is approaching slowly, and the danger can be easily avoided, left side section 9 of motor vehicle 1 is identified by the indicating color, as shown in FIG. 4a. FIG. 4b shows the marking of side section 9 in the case that the foreign vehicle is approaching quickly from the side, and the driver must urgently react to avoid the danger. As described above, side section 9 is marked by a warning color. In addition, an arrow 10 is shown, which points to the right from graphically represented motor vehicle 1 and thus indicates the direction into which the driver must steer to evade the danger. Both here, as well as in other examples, graphically represented arrows 6, 10 advantageously increase in size in response to intensifying danger.

Side section 9 of motor vehicle 1 is likewise marked accordingly by the indicating color or by the warning color when one's own motor vehicle is in a curve and the speed is excessive, left side section 9 being marked when one's own vehicle is in a right-hand curve.

FIGS. 5a and 5b show motor vehicle 1 having an optical marking for the case when the detection unit, respectively the evaluation unit has detected a foreign vehicle that is passing from behind. If the driver information system registers that the driver of one's own motor vehicle does not intend to change lanes, then, as in FIG. 5a, left rear corner section 11 is optically marked by a coloration in the indicating color for the case that the foreign vehicle is passing on the left. If the driver information system registers that the driver of graphically illustrated motor vehicle 1 would himself/herself like to change into the lane to the left, then corner section 11 is marked by the warning color. In both cases, even when the foreign vehicle is in the blindspot of his/her motor vehicle, the driver is made aware of the foreign vehicle and of a potential danger.

FIGS. 6a and 6b show motor vehicle 1 in a situation where an unexpected obstacle was detected to the left in the front, when viewed in the driving direction. Here, the driver is made aware of the obstacle by a colored marking of left front corner section 12 and an additional rightward pointing arrow 13, and is prompted to steer to the right. The distinction is made in this exemplary embodiment, in turn, between an indication of the obstacle (FIG. 6a) and a warning of a critical danger posed by the obstacle (FIG. 6b), in the latter case, corner section 12 and arrow 13 being marked by the warning color. In addition, in the case of a critical danger, arrow 6 is graphically represented, which signals or suggests a braking action to the driver of the motor vehicle, in order to avoid the danger.

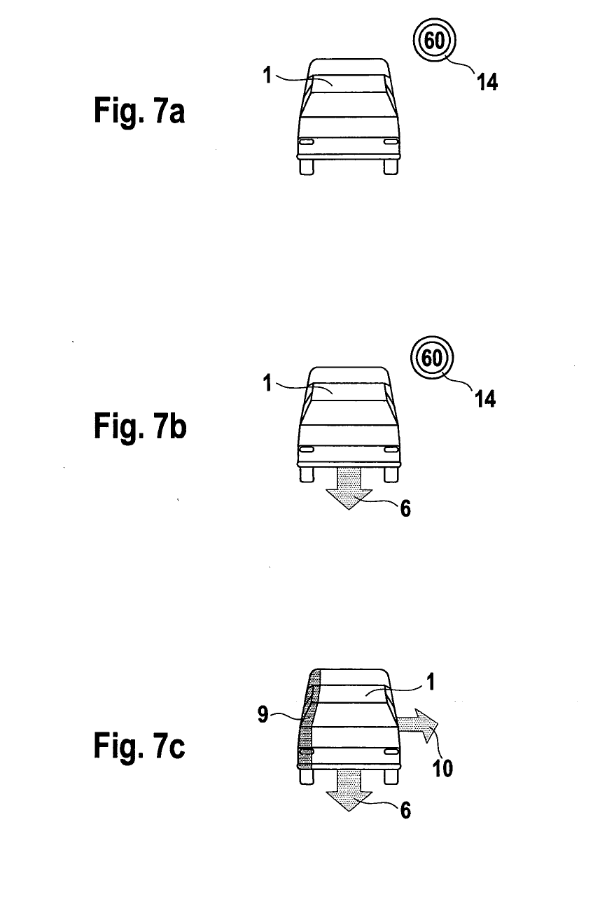

FIG. 7a through 7c show the graphical representation of motor vehicle 1 in the case of excessive speed of one's own motor vehicle. In a first stage (FIG. 7a), a warning symbol in the form of a traffic sign 14 is initially displayed to make the driver aware of the highest permitted speed. If the driver information system, respectively the detection unit is capable of detecting traffic symbols, then traffic sign 14 may be displayed accordingly. Otherwise, traffic sign 14 merely represents a warning symbol whose purpose is to indicate that the speed of one's own motor vehicle is generally too high, respectively is too high for the current driving situation. If the speed is selected to be too high, additional arrow 6 prompts the driver to brake (FIG. 7b). If the driver information system recognizes that the vehicle is in a curve, i.e., in a right-hand curve as shown in FIG. 7c, and also recognizes that the speed is selected to be too high for this curve, then, as in FIG. 4a, left side section 9 is marked in color with the warning color and, in addition, arrow 6 is displayed as a brake prompt, respectively braking recommendation to avoid danger, and arrow 10 is shown as an indication to steer. Just by glancing at graphically represented motor vehicle 1, as shown in FIG. 7c, the driver not only knows that danger is imminent, but also knows how he/she must react, namely by braking and steering to the right to avoid the danger.

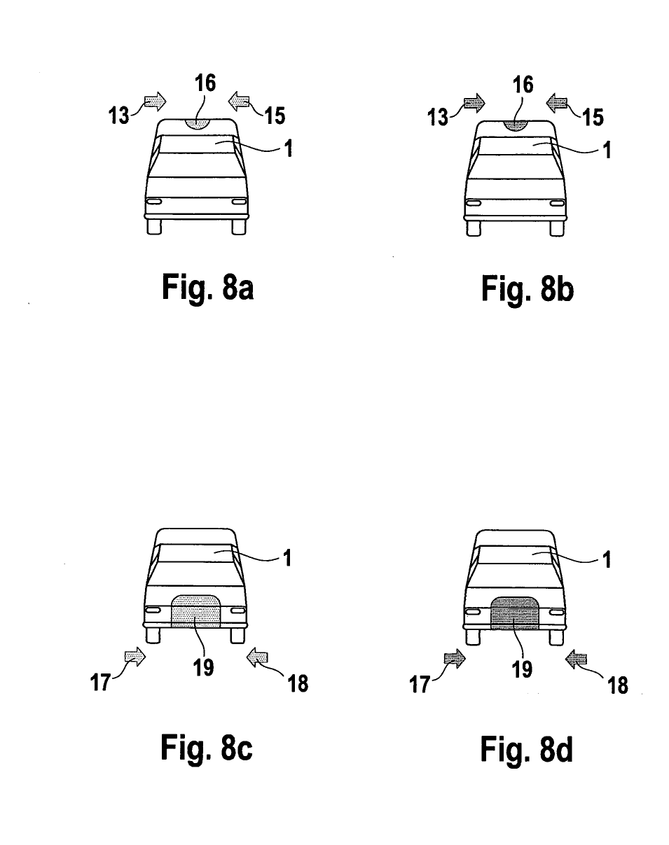

FIG. 8a through 8d show exemplarily various possible representations of the display unit for the case that the roadway on which one's own motor vehicle is located, is not clear in front of one's own motor vehicle (FIGS. 8a and 8b) or behind one's own motor vehicle (FIGS. 8c and 8d). To that end, two arrows 13 and 15, which point toward each other, are displayed, each being marked with the indicating color or the warning color, depending on the danger level. In addition, middle front section 16 of motor vehicle 1 is marked in the appropriate, corresponding color. The equivalent holds true for FIG. 8c and 8d, in each case, two arrows 17 and 18, which point toward each other, being indicated behind motor vehicle 1 in the appropriate, corresponding color. In addition, in this case, middle rear section 19 is marked with the indicating color or the warning color. The coloration of arrows 13, 15, 17 and 18 and of middle front section 16 and of middle rear section 19 does not necessarily need to be dependent on the speed of one's own motor vehicle or of a foreign vehicle. This supplementary information is also displayed, for example, when one's own motor vehicle is standing, the coloration differing depending on whether a gear is engaged or not, so that, in some instances, such as in a traffic jam, the driver is alerted to shift into neutral.

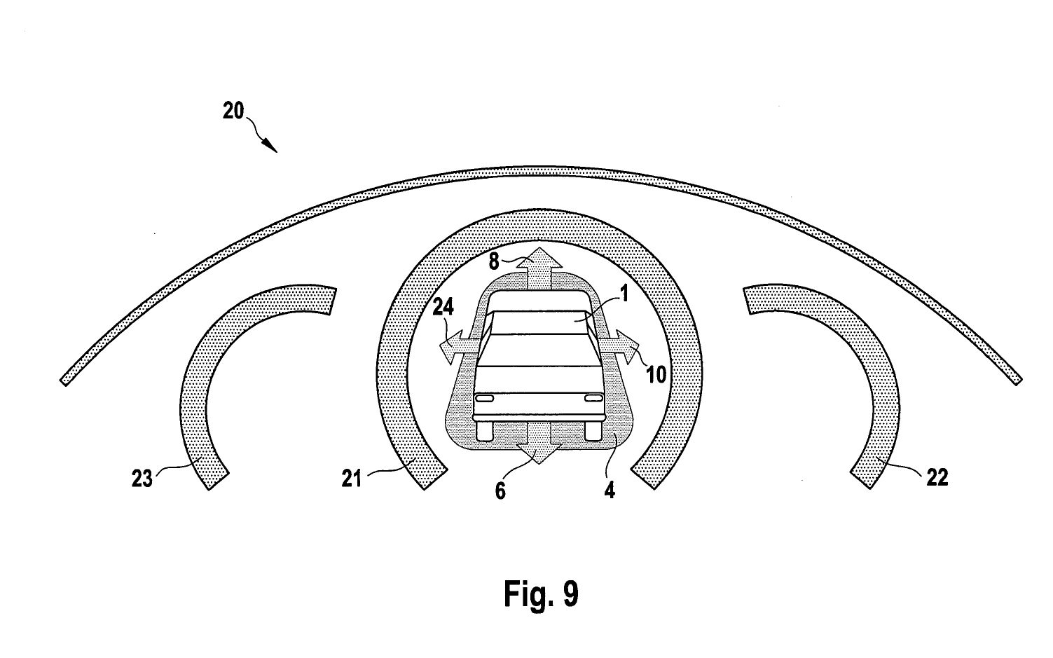

In one exemplary embodiment, FIG. 9 shows a schematic configuration of the display unit in instrument panel area 20 of one's own motor vehicle. In this case, it is situated in the middle of a speed indication 21, between a tachometer 22 and a fuel level indicator 23. In the example shown here, motor vehicle 1, together with aura representation 4, arrows 6, 8 and 10, and an arrow 24 pointing oppositely to arrow 10 are depicted. In operation, these are, of course, not all displayed at once. As soon as danger is detected, first aura representation 4 disappears, so that the driver of the motor vehicle is first alerted to a danger, and, via the supplementary information, subsequently receives a prompt suggesting how to avoid the danger.

1-7. (canceled)

8. A method for informing a driver of a motor vehicle via a driver information system, which has at least one detection unit, at least one evaluation unit, and at least one optical display unit, the method comprising:
displaying, with the display unit, the motor vehicle having the driver information system as a graphical representation, an aura representation surrounding the graphical representation when, based on evaluation of data from the detection unit, the evaluation unit determines that there is no immediate danger;
if an imminent danger is ascertained in a corresponding manner, changing or making disappear the aura representation changes; and
displaying at least one supplementary information item for avoiding danger.

9. The method of claim 8, wherein an optical marking identifying an area of the graphically represented vehicle that is at risk is provided as supplementary information.

10. The method of claim 8, wherein a vehicle-control instruction linked to the graphical representation of the motor vehicle is indicated to the driver as supplementary information.

11. The method of claim 8, wherein it is indicated whether the graphically represented area of the motor vehicle that is at risk is endangered by at least one of other objects and by a driving maneuver of the driver.

12. The method of claim 8, wherein the supplementary information item includes at least one of a suggested driving maneuver for the driver and a suggested preparation for a driving maneuver for the driver to execute.

13. The method of claim 12, wherein the suggested driving maneuver is indicated by at least one arrow extending out from the graphically represented motor vehicle.

14. The method of claim 8, wherein the display unit displays at least one supplementary information item on a status of the motor vehicle.
